(19) United States
(12) Patent Application Publication
(10) Pub. No.: US 2013/0244306 A1
(43) Pub. Date: Sep. 19, 2013

(54) MICROBE FOR REDUCING TOTAL DISSOLVED SOLIDS FROM WASTEWATER

(71) Applicant: Krishna Prasad M., Ghaziabad (IN)

(72) Inventor: Krishna Prasad M., Ghaziabad (IN)

(21) Appl. No.: 13/989,799

(22) PCT Filed: Nov. 2, 2011
(86) PCT No.: PCT/IN2011/000755

§ 371 Date: May 26, 2013

(30) Foreign Application Priority Data
Nov. 26, 2010 (IN) 2812/DEL/2010

(51) Int. Cl. C02F 3/34

(52) U.S. Cl. CPC C02F 3/34
USPC 435/252.1

(57) ABSTRACT

The present invention relates to a bacterial strain useful for reducing the total dissolved solids (TDS) levels from industrial waste water. The microbe which is invented in the process is having the immense capacity to reduce TDS from 11000 to 6000 in just few seconds. Microbe which has been generated is named Poseidon which is a greek word and is synonym for Sea God. When Poseidon was applied to water mixed with diesel it was found that the ph of water was not changing and diesel was converted into semisolid layer suspended on the superficial layer of water for enabling easy removal from water. Henceforth Poseidon was recognized for spraying on the oil pills for removal of oil pills in dirty water with disturbing and causing any harm to marine life. Industrial waste waters contain hazardous compounds which are treatment, and is very cost effective, with negligible waste water as a byproduct without harming the environment. This technology can be used to treat the industrial waste water and make it fit for reuse so that the available water is used again without disturbing the ground water table. Now a day's water pollution is the biggest problem that is faced by the entire globe. So this is a step towards the problem to clean the water without using harmful chemicals.

### NEED FOR INVENTION

It has been observed that whole world id entering in to a water crises. The availability of water is decreased in the surface as well as surface reservoir. The growth of population as well as constant growth of industries has increase the consumption of water. Though the constant decrease in the water level is notified in the water reservoir. henceforth it is decided to argumental need of human being under life stock by reusing the waste water and prohibiting further pollution of the ground as well as surface water reservoir. It is felt that the present-day need is to improve the quality of existing reservoir, aquafires as well as by reuse of water and hence by arrest the further depletion of the water resources. Hence this innovation

The subject of treating the waste water had been dealt by the several people with several existing technology as well as promoted water technologies. But all the technologies till date has proved to be not only prohibitably costier but also do not reclaim I recover 100 percent of the water from waste water. The important factor which has been the major trouble in water treatment technology is addressing the issue of TDS (Total Dissolved Solids).

The oxygen demand of water had been argumented by infusion of oxygen and various aeration processes. But reduction of TDS (Total dissolved Solids) has not been a success. The present day technologies such as reverse osmosis combined with ultra filtration could only achieve a recover rate of Fourty percent of water from waste water.

The astringent pollution control norms raised by the country and state has reserved the rate of adoption of technology which reserves sixty percent of water. The electric consumption for undertaking both activities is enormous and huge. Hence this innovation to recover hundred percent of water from waste water without spending expensive electricity which is also produced by emitting of carbon in the thermal plant.

### INGREDIENTS OF INNOVATION

A microbial treatment to reduce the TDS (Total dissolved Solids) was registered as a patent as an idea

Further to registration search was conducted and within the limited time frame a microbe with the capacity to reduce TDS (Total dissolved Solids) from all sorts of waste water which improves different pH values that is highly acidic and highly alkaline as well as high TDS (Total dissolved Solids) was achieved. The available microbes emerging out of lactobacillus species study was undertaken and no appropriate result s were achieved. Microbes germinating out of decomposed vegetables waste also tried but no remarkable results were achieved.

Hence it was decided to create a new microbe which is probiotic in nature and has the capacity to cleans the water by mixing multiple organic materials which has got the capacity to decompose, germinate microbe under aeration.

Process:

Lactobacillus genera as identified suitable to be developed into a microbe which has the capacity to reduce TDS (Total dissolved Solids) because of its probiotic nature.

A variety of grass and mass material which has got faster bio-degradable capacity of high quality had been identified and mixed with curd and water will germinated along with the component by decomposition. though the shape of microb is rod shaped apparently to be lactobacillus but since the germination and multiplication is done under special condition varying all the organic material used during germination and multiplication are biodegradable and hence the capacity to create a microbe of its own. Hence it is understood that by infusion of continuous aeration and blended mixture of all these organic compound a new microbe is created and it is names Poseidon.

Why it is called Poseidon:

Since it is felt understood and established that a new microbe has been created which has the enormous capacity to reduce the TDS (Total dissolved Solids) and neutralize pH.

A new name to the microbe has to be given keeping in pending the finalization of the generic name of microbe by understanding nature of the species it belongs to name and nomenclature has known given to it. This name and nomenclature does not prohibit and as well as reserve the right for further investigating and finalizing any generic code. This microbe is named as Poseidon because of its enormous capacity to clean the water and Poseidon being a greek name for sea God it is been thought fit and forthright.

Achievements:

Poseidon is applied into waste water generating out of Industries having pH value of 13.5 and TDS (Total dissolved Solids) of 11000 it was found to be neutralizing pH to 7.5 and reduce TDS (Total dissolved Solids) to 6000 within seconds of application.

When Poseidon was applied into waste water generating out of chromium mine it was found to reduce the TDS (Total dissolved Solids) from 500 to 50.

When Poseidon was applied into automobile waste water it was found to achieve a reduction of TDS (Total dissolved Solids) from 600 to 400 and pH from 8 to 6.5

When Poseidon was applied in hydrochloric acid with ph of 0.09 it was neutralized to ph to 6.8.

When Poseidon was applied to water mixed with diesel it was found that the ph of water was not changing and diesel was converted into semisolid layer suspended on the superficial layer of water for enabling easy removal from water.

Henceforth Poseidon was recognized for spraying on the oil pills for removal of oil pills in dirty water with disturbing and causing any harm to marine life.

Team of researchers:

This research is conducted by Mr. Phani Aumar Chaparala under the direct supervision of Ms. Raphael William with the guidance and original idea generation of Mr. M. Krishana Prasad.

We claims:

1. The microbe generated in the process is of its own kind and relates to a different species which is having the immense capacity to clean the waste water which is named as POSEIDON is synonym for Sea God.

2. The microbe claimed in claim 1 having the capacity to reduce the pH of waste water to neutral. pH.

3. The microbe claimed in claim 1 have immense capacity to clean the waste water by reducing TDS (Total Dissolved Solids) from water drawn from natural resources as well as other ground and surface water reservoir.
